(19) United States
(12) Patent Application Publication
(10) Pub. No.: US 2008/0125162 A1
(43) Pub. Date: May 29, 2008

(54) Communication Device, Method For Providing Data, And Corresponding Interface

(76) Inventors: Ralph Schraven, Krefeld (DE); Frank Muller, Aachen (DE)

Correspondence Address: COLLARD & ROE, P.C., 1077 NORTHERN BOULEVARD, ROSLYN, NY, 11576, US

(21) Appl. No.: 11/664,443

(22) PCT Filed: Sep. 19, 2005
(86) PCT No.: PCT/DE2005/001644

§ 371 Date: Apr. 2, 2007

(30) Foreign Application Priority Data
Oct. 1, 2004 (DE) 102004048377.9
Mar. 2, 2005 (DE) 102005010146.1

(51) Int. Cl. H04M 1/00

(52) U.S. Cl. 455/550.1

(57) ABSTRACT

To further simplify the input of information into a communication device, the present invention suggests a communication device, in particular a mobile telephone, for using information which is provided to the communication device incorporated in data, such as image data, having a recognition unit for ascertaining the information incorporated in the data, the communication device having at least two different operating modes and, in addition, a control unit, using which the communication device may be switched over at least from a first operating mode into a further operating mode.

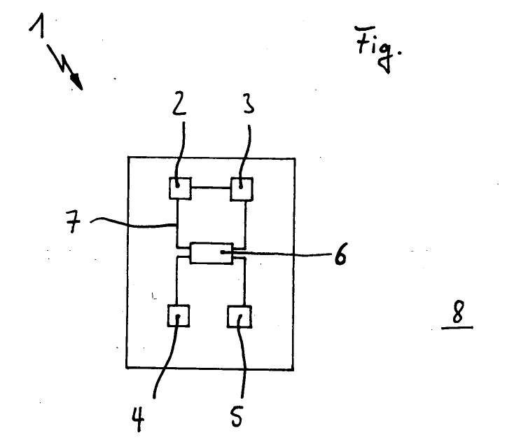

The present invention firstly relates to a communication device, in particular a mobile telephone, for using information which is provided to the communication device incorporated in data, such as image data, having a recognition unit for ascertaining the information incorporated in the data. In addition, the present invention relates to a method for providing information which is contained in data, such as image data, to a communication device, such as a mobile telephone, in which the data is input wirelessly into the communication device using an input unit. Moreover, the present invention relates to an interface for the wireless input of information into a communication device.

For expanded usage of a communication device, such as a mobile telephone, inputting data into the communication device to be able to use these expanded functions has become typical. Typical methods require necessary information to be input by manual input via a keypad or using an input via electrical data lines and/or via special data carrier media or appropriate read devices as well as via radio or infrared interfaces. Inputs of this type are often performed in connection with the following exemplary applications. For example, if mobile data services are to be used via the Internet by a mobile telephone, a specific address must be specified in each case to be able to retrieve a corresponding Internet site. This address typically comprises numbers, letters, and/or special characters. Putting further entries in a list of telephone numbers of the mobile telephone typically also requires alphanumeric inputs, in particular if, in addition to one or more telephone numbers, the names associated therewith and further information are also to be stored.

In mobile telephones, however, there is often only a small keypad, which only offers a few further keys in addition to the ten numbers 0 through 9. A data input via a keypad of this type is therefore not very user-friendly.

In addition, equipping mobile telephones in particular with at least one further, preferably wireless input interface, via which information may be input into the mobile telephone, is known. The user-friendliness during data input into the mobile telephone is significantly more comfortable using the wireless input interfaces than the manual input via a keypad and is thus improved. Wireless input interfaces of this type may be integrated into the mobile telephone by a speech recognition unit, a radio unit, such as Bluetooth, WLAN, or using an infrared interface (IrDA). These wireless input interfaces make it significantly easier to deal with the mobile telephone or a similar mobile device when inputting information, but make the mobile telephone more costly at the same time and are often difficult to operate, in particular for inexperienced users.

It is the object of the present invention to provide a communication device, such as a mobile telephone, and/or an input interface, using which the input of data into a mobile telephone in particular is significantly simplified and made more user-friendly.

The object of the present invention is achieved by a communication device, in particular a mobile telephone, for using information, which is provided to the communication device incorporated in data, such as image data, having a recognition unit for ascertaining the information incorporated in the data, the communication device having at least two different operating modes and, in addition, a control unit, using which the communication device may be switched over at least from a first operating mode to a second operating mode.

As defined in the present invention, the term “communication device” comprises all those devices which are capable of data recording of any type. Information which is contained in the recorded data may preferably be used or at least temporarily stored using these communication devices until the communication device is connected to a corresponding data processing device, such as a PC or laptop, and the information incorporated in the data may be used on this data processing device cumulatively or alternatively to the communication device. For this purpose, mobile communication devices, in particular mobile telephones are in the foreground. However, PDAs or other handheld terminal devices are also included by the term “communication device”.

The term “information” is understood in the present case to mean data packets which have special formats which are different from formats of the remaining data. Therefore, the data packets having the special formats are differentiable from the remaining data and the data packets may be recognized in a data pool and extracted therefrom. Information of this type may be represented in particular as optical codes, such as characters, barcodes, or two-dimensional matrix codes or other symbols contained in image data. In addition, the term “information” implies any information which may be transmitted to the communication device wirelessly, for example, by electrical, magnetic, or electromagnetic transmission pathways. In this application as well, the information is distinguished by special data packet formats, on the basis of which the information may be recognized from a data pool.

In the present case, any unit which is capable of recognizing information located in the data and extracting it from the data is considered a “recognition unit”. In the meaning of the present invention, the recognition unit is preprogrammed with the special formats in such a way that the recognition unit may recognize data in these special formats. Ideally, the recognition unit permits updates, by which it may also be sensitized later to new information to be recognized.

In the meaning of the present invention, the term “control unit” describes a unit, using which it is possible to activate and/or deactivate at least one operating mode of the communication device. In addition, it is possible using the present control unit to operate the communication device and/or the recognition unit in different search modes. The control unit thus makes it possible to switch back and forth between various operating modes. The control unit may be implemented both as hardware and also as software in the meaning of the present invention. In addition, it is possible that the control unit controls various recognition units and/or coordinates functions of various recognition units with one another. If the recognition unit is a unit which processes optical images, the control unit may switch back and forth between a video mode and a single image mode. In addition, it is possible that the control unit controls the function of a further recognition unit on the basis of information which was ascertained by a first recognition unit from data.

According to the present invention, for this purpose a first search mode, which is known in the present case as the low data search mode, is permanently turned on, so that the low data search mode represents a basic mode of the communication device. If the quality of the information provided falls below a critical value, from which the information may no longer be recognized using the low data search mode, the communication device may switch or be switched into a further operating mode, which is referred to in the present case as the high data search mode. The changeover into the high data search mode may be caused by an action of the user or may be performed by the communication device and/or its control unit without operation of the user.

Because the communication device is continuously in a basic mode in which in particular the recognition unit searches continuously in data for information which may be evaluated, information is input directly into the communication device as soon as it is favorably brought into the proximity of data having information. In this way, a user advantageously no longer has to initiate or perform information or data input manually, because of which the operation of the communication device is significantly simplified.

It is advantageous if the communication device has a low data search mode and a high data search mode and may be switched over from the high data search mode into the low data search mode using the control unit. The high data search mode has a higher resolution quality than the low data search mode. However, there is no reason that further modes may not be provided on the communication device.

In this context, the object of the present invention is also achieved by a method for providing information which is contained in data, for example, in image data, to a communication device, such as a mobile telephone, in which the data is input wirelessly into the communication device using an input unit, and in which information, which is distinguished by special data formats, contained in the input data is permanently ascertained to be able to provide the information immediately if it is present.

Because information is permanently being ascertained, it is also no longer necessary for a user of a mobile telephone, for example, to act himself to ascertain information in data.

In the meaning of the present invention, the term “input unit” is understood to mean any units, using which data and/or information located therein may be input wirelessly into the communication device. In the meaning of the present invention, an input unit of this type may be an electrical camera of a mobile telephone or contain such a camera, for example. However, in the present case it may also be implemented by an RFID read device (radio frequency identification) and/or a NFC component (near field communication).

In a preferred method variation, a low data search mode is preset for permanently ascertaining information. This low data search mode is a basic mode in which the mobile telephone is preferably permanently operated.

It is advantageous if the information is ascertained for the user without operation in the low data search mode. It is not necessary, as was typical up to this point in the prior art, for a trigger to be actuated manually by the user after the communication device is oriented in order to ascertain the targeted information. Rather, in the present case the input unit of the communication device is only still positioned in proximity to the information in such a way that the input unit is capable of inputting the information and/or the data having information, without the user having to perform a special action on the communication device for this purpose. The recognition unit automatically ascertains nearly simultaneously whether the input data contains usable information and/or whether input information is desired information.

In addition, it is advantageous if there is a changeover from a low data search mode into a high data search mode as needed. This is advantageous in particular if a higher resolution quality for recognizing information provided in data is necessary for providing information, if the information may not be clearly recognized and thus ascertained by the recognition unit in the low data search mode. This changeover between the low data search mode and the high data search mode preferably occurs manually. It is obvious that a changeover between two operating modes may also occur automatically.

If the communication device is in the high data search mode, for example, it is advantageous if it switches over from the high data search mode into the low data search mode after information is successfully ascertained and/or after a time limit is exceeded.

Cumulatively or alternatively, it is advantageous if there is a changeover from a low data search mode into a high data search mode as a function of the data and/or information available. For example, if information is not clearly recognizable by the communication device, the communication device advantageously switches over automatically from the low data search mode into the high data search mode to thus possibly still be able to clearly recognize the information.

To be able to input data wirelessly into the communication device according to the method described above, it is advantageous if the communication device has an input unit for the wireless input of the data.

In a preferred embodiment variation, the recognition unit incorporates the control unit. The communication device thus has an especially compact construction.

In order that the recognition unit may recognize information of varying quality, it is advantageous if the recognition unit has more than one operating mode.

In a further preferred embodiment variation, the recognition unit has a decoding unit for decoding information incorporated in image data. This decoding unit is preferably implemented as software. However, it may also be provided as an independent physical assembly in the communication device.

In addition, it is advantageous if the recognition unit cumulatively or alternatively has a receiver unit for electrical, magnetic, and/or electromagnetic fields. It is thus possible to input information which is not optically represented in image data using the communication device.

In this context, it is advantageous if the receiver unit has an RFID read device and/or an NFC component. If the recognition and/or receiver unit is an RFID read device or an NFC component, the control unit advantageously switches back and forth between a far mode and a near mode depending on the range for which the communication device is to be receptive. Cumulatively or alternatively, the control unit may switch between an active mode and a passive mode, depending on whether the communication device is to be receptive to data on passive transponders.

In order that a user may select between the individual operating modes independently of a control unit, it is advantageous if the communication device has means for manually selecting a search mode. It is obvious that further operating modes may also be selected via these selection means.

It is advantageous if the communication device has means for displaying an operating mode to rapidly inform a user about which operating mode is currently set.

Using the present communication device and/or the method related thereto for providing information in connection with the communication device, a technique is provided, using which it is possible to ascertain information without a key operation by a user being necessary. Precisely the simplified input capability is of ever greater significance in the future, because mobile data services will be expanded further and further in the future and accordingly will be used more and more frequently by users.

In the following, a mobile telephone which is equipped with an optically operating input unit, using which optically provided information may be input into the mobile telephone, is described as an example of an advantageous embodiment of the present invention. The input unit preferably comprises a camera installed in a mobile telephone or plugged into a mobile telephone. The input unit is connected to a decoder unit, which is capable of decoding optical codes, such as characters, barcodes, or two-dimensional matrix codes.

Using a mobile telephone modified in this way, for example, the contact information printed on a business card may be read and added to the address book of the mobile telephone. For this purpose, this information merely has to be printed on the business card in a format supported by the recognition unit and/or decoding unit. Such a format may be a barcode symbology or a 2D matrix symbology (such as data matrix), for example. In addition to the characters already cited above, printing readable by the recognition unit or even handwriting may also be input. It is also possible to input an optical code together with an illustrated advertisement or printed on an advertising poster, whose information comprises a URL, for example. Instead of having to input the URL cumbersomely using the numeric keypad, the user may easily look up the web site cited in the advertisement.

In a first input mode (low data search mode) the camera continuously provides images recorded using a high image repetition rate. In this context, the low data search mode is also referred to in the following as the “video mode”. These images are displayed on the display of the mobile telephone. Because of the high image repetition rate, the user receives a fluid image display and may continuously judge image detail and quality (e.g., sharpness, brightness, contrast) of the image seen by the camera. Simultaneously, the images recorded by the camera are continuously relayed to the decoding unit. To achieve a high image repetition rate, the input unit operates using camera images of reduced local resolution and/or the decoding unit operates using limited computing effort. It is thus possible in the video mode to input optical codes if the codes are shown in the recorded images in sufficiently high quality and resolution and, in addition, the computing effort for the decoding does not exceed a critical computing effort allotted to the video mode.

If a code is read and/or decoded in the video mode, the mobile telephone may signal a successful reading and/or display the input information, execute an action directly using the input information and/or branch into a dialogue, using which a user may determine the further use of the input just made. For example, if a telephone number or a digital business card is read and/or decoded, the user may select between the functions “add to address book, call a person, or terminate action”. For example, if a URL is decoded, the user may select between “add to Internet favorites, retrieve the associated Internet site, or terminate the action”.

In contrast, if a code is not read and/or decoded in the video mode, for example, because of too high a detail resolution of the code and/or too low a local resolution of the camera images, it is possible that the mobile telephone switches over or is switched over into the high data search mode. In the high data search mode, the camera inputs a single image of the highest possible quality and resolution and provides this to the recognition unit and/or the decoding unit. In this context, the high data search mode is also referred to in the following as the “single image mode”. In the single image mode, the computing effort for the recognition unit and/or for the decoding unit is not limited or is limited less than in the video mode.

It is obvious that a successful reading may be signaled, the input data may be displayed, it may branch into a dialogue, and/or an action may be executed directly by the mobile telephone in the single image mode.

To signal the particular active operating mode to a user, it is possible to superimpose a graphic on the image shown in the display of the mobile telephone or to show it in a possibly colored frame. Clear signaling of the single image mode is especially advantageous, because it may be accompanied by “freezing” of the image. Due to the signaling, the user may easily recognize it because of the “freezing” and does not confuse this phenomenon with a malfunction.

Independently of whether a code was read in the video mode or in the single image mode, the mobile telephone may deactivate or activate and/or keep active the input unit and/or the recognition unit. Keeping the input unit active is advantageous in particular in the cases in which a further input is advisable or necessary. For example, after reading a data matrix code, it is established on the basis of the content of this data matrix code that further data is contained in further data matrix codes (structured append). It would then be advantageous to switch the input unit to the video mode and/or leave it there after the reading, to achieve a fluid image preview.

It is especially user-friendly and thus advantageous if the recognition unit is first in the video mode. The user is thus offered a “fluid” preview on the display of the mobile telephone and may thus position the mobile telephone optimally in relation to the optical code. If the code is already readable in the video mode, it is read directly without performing a further user action.

If the code is not read in the video mode, it is advantageous if the user may switch the mobile telephone over into the single image mode. This may be performed by actuating a corresponding mobile telephone key, for example. A high-resolution camera image is recorded and both relayed to recognition unit and/or decoding unit and also displayed as a preview image in the display of the mobile telephone. Furthermore, it is advantageous in the event of unsuccessful reading in the single image mode if the mobile telephone is automatically switched over into the video mode, i.e., without requiring an action of the user for this purpose, which offers a fluid image preview and thus permits comfortable positioning of the device in relation to the code to be read.

Cumulatively or alternatively, the mobile telephone is equipped with an electrically, magnetically, or electromagnetically operating input unit. The input unit may particularly be an NFC or RFID the device, using which information located on an ID label or a contactless smartcard may be input into the mobile telephone. It is also advantageous for this purpose if the input unit may be operated in various operating modes.

For example, the input unit has a near mode, in which data may only be read from an ID label or a smartcard when it is located in direct proximity to the mobile telephone. In addition, the mobile telephone preferably has a far mode, in which data may also be read from labels or smartcards which are further away. Cumulatively or alternatively, the input unit has a passive mode and an active mode. In the active mode, data is only read from active transponders, in the passive mode, data is read from both active and also passive transponders.

It is obvious that both an optical input unit (camera) and also an NFC and/or RFID read device may be provided in the mobile telephone. For example, the RFID read device may be used for inputting configuration data for a controlling application and/or for the optical input unit. For example, it is possible to read out an RFID label attached to a poster wall or a transponder attached thereto having access data for a mobile information service, the individual information retrievals being initiated by the input of optical codes, which are in turn located on posters of the poster wall. The optical input unit is started in an operating mode suitable for the application or switched over to an operating mode suitable for the application only by input of the access data using the NFC or RFID read device, and the information subsequently input via the optical input unit is interpreted in a way suitable for the application, for example, as an addition to a base address indicated in the access data. It is possible in particular that the access data incorporated in the transponder also contains a part which describes a service, a report, or an access method.

The object of the present invention is also achieved by an interface for the wireless input of information into a communication device, the interface having at least two operating modes to ensure the input of information as a function of its quality. This interface allows especially simple operation of a device which is capable of recording data and ideally processing it. In contrast to typical interfaces, the interface according to the present invention is capable of selecting the particular favorable operating mode independently depending on the quality of the data provided and/or the information contained therein. In this way, information may be input and decoded directly in the device provided for data recording without great effort.

Further advantages, properties, and goals of the present invention are explained on the basis of the drawing appended to the following description.

The FIGURE schematically shows a mobile telephone having a control unit for switching over between a low data search mode and a high data search mode.

The mobile telephone 1 shown in the single FIGURE is equipped with a camera 2 as an optical input unit, having a decoder unit 3 as a first recognition unit, an RFID read device 4 as a further input unit and/or recognition unit, an NFC component 5 as an alternative input unit and/or recognition unit, and a separate control unit 6 for controlling the individual component assemblies 2, 3, 4, and 5. All component assemblies are connected using a circuit 7.

The present mobile telephone 1 is set in a base setting so that it is continuously in a low data search mode. In this low data search mode, the camera 2 receives image data continuously from the mobile telephone environment and conducts this image data continuously using the circuit 7 to the decoding unit 3. The decoding unit 3 ascertains information incorporated in the image data to decode it immediately and directly. An engagement of the user of the mobile telephone 2 is not necessary for this purpose.

Simultaneously, the RFID read device 4 and/or the NFC component 5 ascertains information in the form of electrical fields in the mobile telephone environment 8.

In regard to the camera 2 and/or the decoding unit 3, the low data search mode has a video mode in which many images per unit of time having few pixels are transmitted from the camera 2 to the decoding unit 3. In regard to the RFID read device 4 and the NFC component 5, the low data search mode has a near mode, in which only information from a transponder (not shown here) which is located in direct proximity to the mobile telephone 1 may be received. For example, in a case of this type, the distance between transponder and mobile telephone 1 must be less than 10 cm.

If information may not be ascertained in the video mode or in the near mode, there may be a changeover from the low data search mode into the high data search mode using the control unit 6. In this exemplary embodiment, this is performed manually by the user of the mobile telephone 1.

Using the camera 2 and/or the decoding unit 3, in the high data search mode, few images per unit of time having many pixels are transmitted, so that the decoding unit 3 may decode high-resolution optical codes and/or high-resolution optical information and provide the information contained therein.

If the mobile telephone 1 is in the high data search mode, the RFID read device 4 and the NFC component 5 are switched over into a far mode, so that information which is further away may be input and/or ascertained by the two input and/or recognition units 4, 5.

In this exemplary embodiment, the decoding unit 3 and the input and/or recognition units 4, 5 are controlled in their function using the control unit 6. For example, the control unit 6 automatically switches back from a high data search mode into a low data search mode as soon as information ascertainment is successfully terminated or a time limit has been exceeded, in which information ascertainment was unsuccessful.

It is obvious that the control unit 6, depending on the embodiment, may be incorporated in the camera 2 of the mobile telephone 1 or, depending on the intended area of application, in the decoding unit 3 and/or in the RFID read device 4 and/or the NFC component 5. In a case of this type, the decoding unit 3 and/or one of the input and/or recognition units 4, 5 would perform the changeover between different operating modes independently.

1. A communication device, in particular a mobile telephone, for using information which is provided to the communication device incorporated in data, such as image data, having a recognition unit for ascertaining the information incorporated in the data, wherein the communication device has at least two different operating modes and, in addition, a control unit, using which the communication device may be switched over at least from a first operating mode to a further operating mode.

2. The communication device according to claim 1, wherein the communication device has a low data search mode and a high data search mode and may be switched over from the high data search mode into the low data search mode using the control unit (6).

3. The communication device according to claim 1, wherein the communication device (1) has an input unit for the wireless input of the data.

4. The communication device according to claim 1, wherein the recognition unit (3, 4, 5) incorporates the control unit (6).

5. The communication device according to claim 1, wherein the recognition unit (3, 4, 5) has more than one operating mode.

6. The communication device according to claim 1, wherein the recognition unit (3, 4, 5) has a decoding unit (3) for decoding information incorporated in image data.

7. The communication device according to claim 1, wherein the recognition unit (3, 4, 5) has a receiver unit for electrical, magnetic, and/or electromagnetic fields.

8. The communication device according to claim 7, wherein the receiver unit has an RFID read device (4) and/or an NFC component (5).

9. The communication device according to claim 1, characterized by means for manually selecting a search mode.

10. The communication device according to claim 1, characterized by means for displaying an operating mode.

11. A method for providing information, which is contained in data, such as image data, to a communication 20 device, such as a mobile telephone, in which the data is input wirelessly into the communication device using an input unit, wherein information contained in the input data, which is distinguished by special data formats, is ascertained permanently to be able to provide the information directly if it is present.

12. The method according to claim 11, wherein a low data search mode is preset for permanently ascertaining information.

13. The method according to claim 11, wherein the information may be ascertained without user operation in the low data search mode.

14. The method according to claim 11, wherein a changeover from a low data search mode into a high data search mode may be performed if necessary.

15. The method according to claim 11, wherein there is a changeover from a high data search mode into a low data search mode after successful information ascertainment and/or after exceeding a time limit.

16. The method according to claim 11, wherein there is a changeover from a low data search mode into a high data search mode as a function of the available data and/or information.

17. An interface for the wireless input of information into a communication device, wherein the interface has at least two operating modes to ensure the input of the information as a function of its quality.
